(19) United States
(12) Patent Application Publication
(10) Pub. No.: US 2025/0219233 A1
(43) Pub. Date: Jul. 3, 2025

(54) ENERGY STORAGE APPARATUS

(71) Applicant: GS Yuasa International Ltd., Kyoto (JP)

(72) Inventor: Keito KATAOKA, Kyoto (JP)

(73) Assignee: GS Yuasa International Ltd., Kyoto (JP)

(21) Appl. No.: 18/847,265

(22) PCT Filed: Mar. 13, 2023
(86) PCT No.: PCT/JP2023/009538

§ 371 Date: Sep. 16, 2024

(30) Foreign Application Priority Data
Mar. 17, 2022 (JP) 2022-042492

(51) Int. Cl. H01M 50/291; H01M 50/209; H01M 50/224; H01M 50/293

(52) U.S. Cl. CPC H01M 50/291; H01M 50/209; H01M 50/224; H01M 50/293

(57) ABSTRACT

An energy storage apparatus includes: an energy storage device array which includes a plurality of energy storage devices stacked in a first direction; a pair of end spacers; a side spacer, and a metal case. The side spacer is coupled to each of the pair of end spacers. The metal case accommodates the energy storage device array, the pair of end spacers, and the side spacer. The side spacer includes a rib protruding towards the energy storage device array. The rib is provided integrally with the side spacer, and is in contact with an energy storage device, among the plurality of energy storage devices, which is in a position facing the rib.

### TECHNICAL FIELD

The present invention relates to an energy storage apparatus that includes: an energy storage device; a holder; and a case.

### BACKGROUND ART

Patent Literature 1 discloses a battery pack which includes a case made of metal and a plurality of battery modules accommodated in the case. The case has a weight portion in a lower portion thereof. The battery module placed on an upper surface of the weight portion is engaged by an engaging portion fixed by a bolt to the weight portion. Accordingly, vertical movement of the battery module is retrained.

### CITATION LIST

### Patent Literature

Patent Literature 1: Patent Application Publication No. 2014-186792

### DISCLOSURE OF INVENTION

### Problems to be Solved by the Invention

In an energy storage apparatus which includes a case made of metal (metal case), just as the conventional battery pack mentioned above, since an outer case has a high mechanical strength, the shock resistance of the entire energy storage apparatus improves. However, if a shock or a vibration is exerted on the outer case, the shock or the vibration propagates to a stack of a plurality of energy storage devices (an energy storage device array) accommodated inside the outer case. As a result, the energy storage device array or each of the plurality of energy storage devices may move. In such a case, a damage to the energy storage device, a malfunction at a joint between the energy storage device and a bus bar, or any other event degrading reliability of the energy storage apparatus could occur. In this regard, the conventional battery pack mentioned above adopts a structure to restrain the vertical movement of the battery module by means of the engaging portion fixed by the bolt to the case. However, in such a case, an operation is required to fix the engaging portion to the case (i.e., bolting operation), and the battery module further requires a structure to be engaged to the engaging portion.

The present invention has been achieved by the inventor of the present invention by newly paying attention to the above problems, and an object of the present invention is to provide an energy storage apparatus having a simple configuration with improved reliability.

### Means for Solving the Problems

An energy storage apparatus according to an aspect of the present invention includes: an energy storage device array which includes a plurality of energy storage devices stacked in a first direction; a pair of end spacers disposed in positions to sandwich the energy storage device array in the first direction; a side spacer disposed on a side of the energy storage device array, in a second direction orthogonal to the first direction, the side spacer being coupled to each of the pair of end spacers; and a metal case to accommodate the energy storage device array, the pair of end spacers, and the side spacer, where the side spacer includes a rib protruding towards the energy storage device array, and the rib is provided integrally with the side spacer, and is in contact with an energy storage device, among the plurality of energy storage devices, which is in a position facing the rib.

### Effect of the Invention

The energy storage apparatus according to the present invention is an energy storage apparatus having a simple configuration with improved reliability.

### BRIEF DESCRIPTION OF DRAWINGS

FIG. 1 is a perspective view illustrating a configuration of an energy storage apparatus 1 according to an embodiment.

FIG. 2 is an exploded perspective view of an energy storage device unit according to the embodiment.

FIG. 3 is an exploded perspective view of an energy storage device array included in the energy storage device unit according to the embodiment.

FIG. 4 is a perspective view illustrating a configuration of an energy storage device according to the embodiment.

FIG. 5 is a perspective view illustrating a configuration of a side spacer according to the embodiment.

FIG. 6 is a sectional view illustrating a structural relationship between energy storage devices and ribs included in the side spacer, according to the embodiment.

FIG. 7 is a sectional view illustrating a structural relationship between the side spacer and the energy storage device array, according to the embodiment.

FIG. 8A is a first perspective view illustrating a coupling structure between the side spacer and an end spacer, according to the embodiment.

FIG. 8B is a second perspective view illustrating a coupling structure between the side spacer and the end spacer, according to the embodiment.

FIG. 8C is a third perspective view illustrating a coupling structure between the side spacer and the end spacer, according to the embodiment.

### DESCRIPTION OF EMBODIMENTS

An energy storage apparatus according to an aspect of the present invention includes: an energy storage device array which includes a plurality of energy storage devices stacked in a first direction; a pair of end spacers disposed in positions to sandwich the energy storage device array in the first direction; a side spacer disposed on a side of the energy storage device array, in a second direction orthogonal to the first direction, the side spacer being coupled to each of the pair of end spacers; and a metal case to accommodate the energy storage device array, the pair of end spacers, and the side spacer, where the side spacer includes a rib protruding towards the energy storage device array, and the rib is provided integrally with the side spacer, and is in contact with an energy storage device, among the plurality of energy storage devices, which is in a position facing the rib.

According to this configuration, movement of the energy storage device array within the metal case can be restricted by means of the end spacers positioned on both sides of the first direction and the side spacer coupling the pair of end spacers. More specifically, the side spacer includes a rib which is in contact with each of the plurality of energy storage devices included in the energy storage device array. For this reason, it is possible to accommodate the tolerance in size of the plurality of energy storage devices, and to align the position of the plurality of energy storage devices in the second direction. That is, the plurality of energy storage devices can be aligned with accuracy, and displacement of the plurality of energy storage devices attributed to vibration, shock, etc. is restrained. Since the rib is integrally formed with the side spacer, no separate member to push the plurality of energy storage devices is necessary. No new structure to be pushed by the rib is necessary for the energy storage device array which includes the plurality of energy storage devices. In this manner, the energy storage device according to the present aspect is an energy storage apparatus having a simple configuration with improved reliability.

One end spacer, of the pair of end spacers, may be coupled to the side spacer in a freely movable state in the first direction with respect to the side spacer.

According to this configuration, the freely movable end spacer is pressurized in the first direction, thereby allowing the energy storage device array to be accommodated in the metal case by pressurizing the energy storage device array in the first direction. By releasing the pressure to the energy storage device array, the energy storage device array can push back the freely movable end spacer, thereby bringing the energy storage device array into a state constrained in the first direction by the metal case. Accordingly, the position of the energy storage device array in the metal case is stabilized. As a result, the energy storage device array has improved vibration resistance or shock resistance.

One of the one end spacer and the side spacer may include a protrusion protruding towards the second direction, and an other of the one end spacer and the side spacer may include an insertion portion into which the protrusion is inserted, the insertion portion being shaped to enable movement of the protrusion towards the first direction, and by insertion of the protrusion into the insertion portion, the one of the one end spacer or the side spacer may be coupled to the other in a freely movable state in the first direction.

According to this configuration, a mechanically engaged state of the end spacer and the side spacer is maintained by a simple configuration of the protrusion and the insertion portion, and a degree of freedom in position of the end spacer with respect to the side spacer in the first direction is maintained.

The side spacer may be made of resin.

According to this configuration, the side spacer is made of resin. Therefore, the side spacer also functions as an insulating member to electrically insulate the energy storage device array from the wall portion of the metal case. The side spacer is a member to couple the pair of end spacers. Meanwhile, constraint of the energy storage device array in the first direction can be performed by the metal case. Therefore, a problem regarding strength of the side spacer due to the side spacer being made of resin hardly occur.

The metal case may include an opening portion which opens towards one side of a third direction orthogonal to the first direction and the second direction, the opening portion being capable of accommodating the energy storage device array, and the side spacer may include a first flange portion which is in contact with an end of the energy storage device array on an other side of the third direction.

According to this configuration, when the metal case is in a posture in which the opening portion is directed upward, the energy storage device array which includes the plurality of energy storage devices, in the state before being accommodated in the metal case, can be supported from below by the first flange portion. Therefore, stability of the energy storage device array improves during an operation to place the energy storage device array into the metal case while pressurizing the energy storage device array in the first direction. Accordingly, the energy storage device array can be accommodated in the metal case with accuracy. This contributes to improvement in reliability of the energy storage apparatus.

The metal case may include an opening portion which opens towards one side of a third direction orthogonal to the first direction and the second direction, the opening portion being capable of accommodating the energy storage device array, and the side spacer may include second flange portion which is in contact with an end of the energy storage device array on the one side of the third direction.

According to this configuration, when the metal case is in a posture in which the opening portion is directed upward, upper ends of the plurality of energy storage devices are pressed by the second flange portion. Accordingly, upward movement of the plurality of energy storage devices is restricted. Accordingly, joining accuracy between a bus bar and an electrode terminal during manufacture of the energy storage apparatus improves. Vibration resistance or shock resistance during usage improves.

The following describes an energy storage apparatus according to embodiment(s) (including modification(s) thereof) of the present invention with reference to the drawings. The embodiment(s) described below each demonstrate either a comprehensive or a specific example.

The numeric value, shape, material, constituting element, disposed position and coupling form of the constituting element, manufacturing process, order of manufacturing processes, and the like, demonstrated in the following embodiment(s) are example(s), and do not intend to limit the present invention. In each drawing, the size, or the like, is not strictly illustrated. In each drawing, same or similar constituting elements are assigned a same reference numeral.

In the following description and in the drawings, an aligning direction in which a pair of electrode terminals included in an energy storage device align, a facing direction in which a pair of short side surfaces of a container of an energy storage device face each other, or a widthwise direction of a metal case is defined to be an X-axis direction. A facing direction in which a pair of long side surfaces of a container of an energy storage device face each other, a thickness direction (flat direction) of a container of an energy storage device, a longitudinal direction of a metal case, or an aligning direction in which an energy storage device included in an energy storage device array and a spacer (holder) align is defined to be a Y-axis direction. A protruding direction in which an electrode terminal of an energy storage device protrudes, an aligning direction in which a container main-body and a container lid portion of an energy storage device align, an aligning direction in which a case main-body and a lid of a metal case align, a facing direction in which an opening portion and a bottom wall portion of a case main-body face each other, or an up-down direction is defined to be a Z-axis direction. The X-axis direction, the Y-axis direction, and the Z-axis direction are directions intersecting each other (orthogonal to each other in the present embodiment). Although there may be case where the Z-axis direction does not conform to the up-down direction depending on a use mode, the Z-axis direction will be described as the up-down direction in the following for convenience of description.

In the following description, for example, an X-axis positive direction indicates a direction of an arrow in the X-axis, and an X-axis negative direction indicates a direction opposite to the X-axis positive direction. When simply referred to as the X-axis direction, it indicates both or one of the X-axis positive direction and the X-axis negative direction. When referred to as one side and the other side of the X-axis direction, it indicates one and the other of the X-axis positive direction and the X-axis negative direction. The same applies to the Y-axis direction and the Z-axis direction. Hereinafter, the Y-axis direction is also referred to as a first direction, the X-axis direction is also referred to as a second direction, and the Z-axis direction is also referred to as a third direction. Expressions indicating relative directions or postures, such as parallel and orthogonal, include cases where the directions or postures are not parallel or orthogonal in a strict sense. Two directions being parallel to each other means not only that the two directions are completely parallel to each other but also that the two directions are substantially parallel to each other, i.e., a difference by several percent or so, for example, is included in the scope. In the following description, when the expression “insulation” is used, “insulation” is intended as “electrical insulation”.

### Embodiment

### [1. General Description of Energy Storage Apparatus]

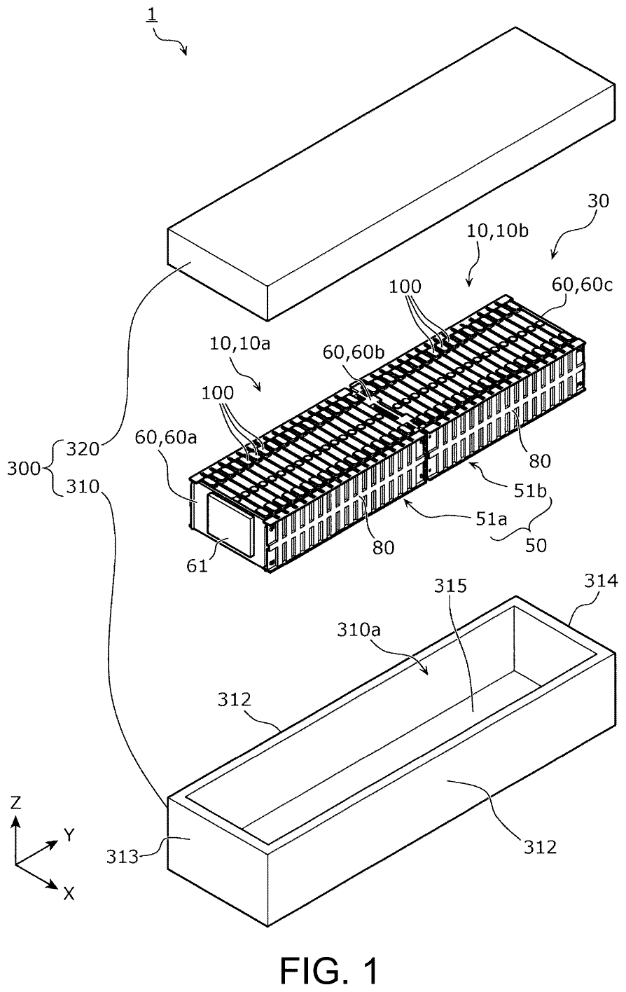

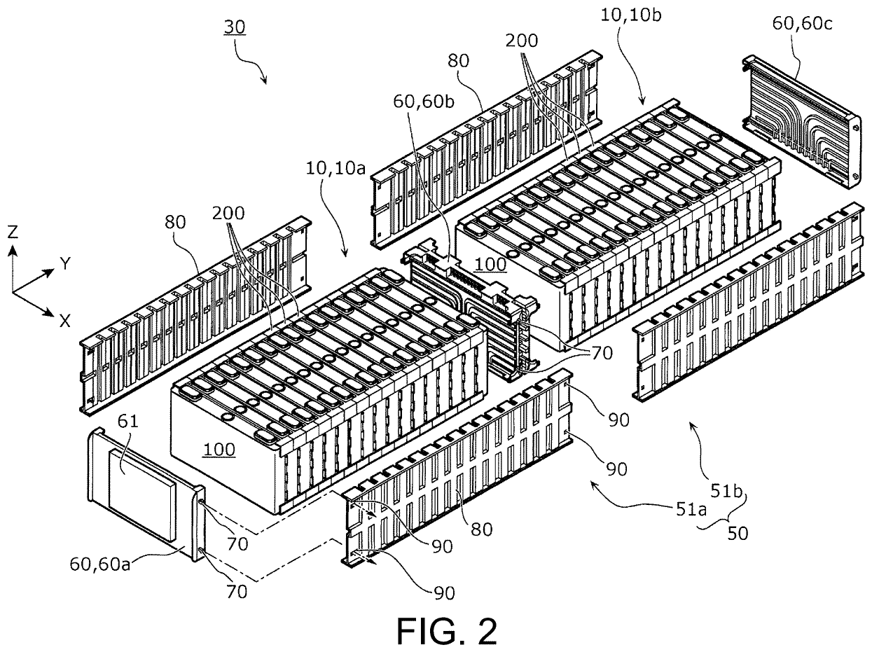

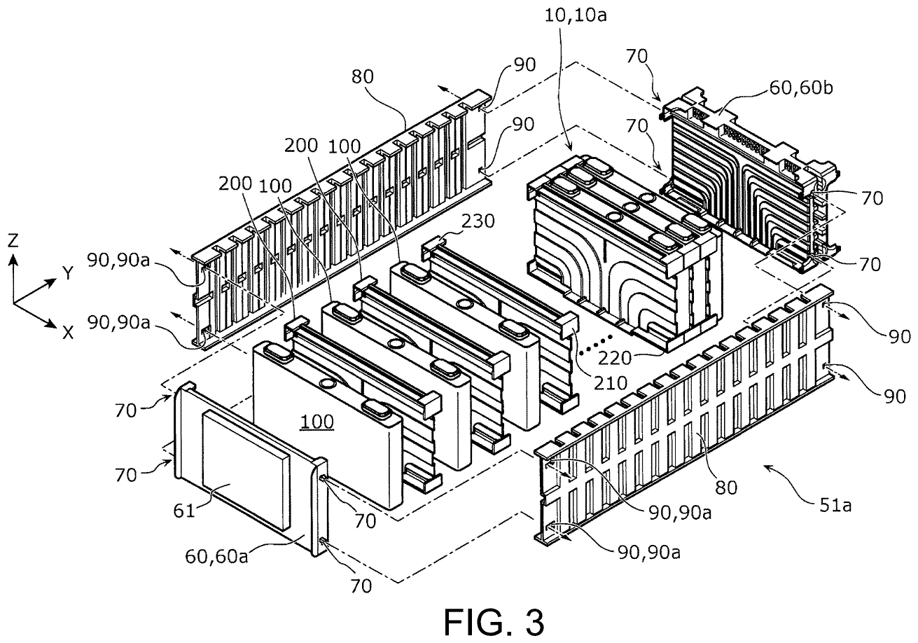

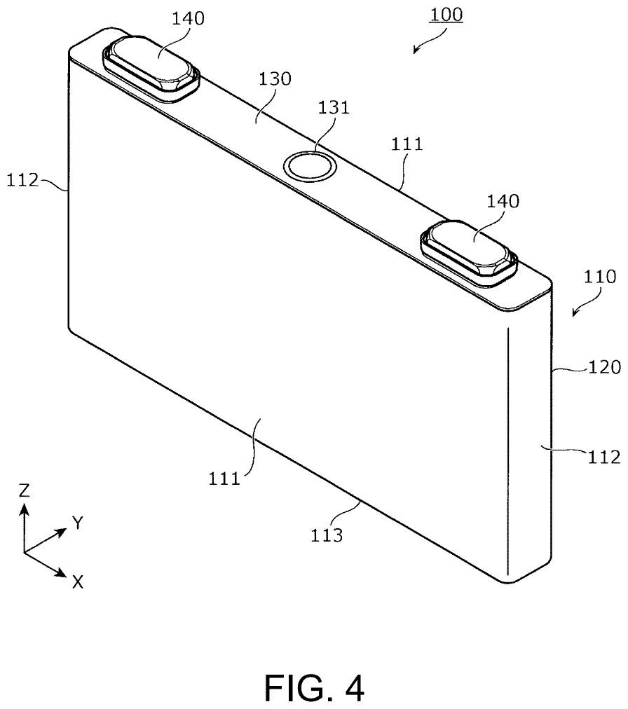

First, an outline of an energy storage apparatus 1 according to the present embodiment will be described with reference to FIG. 1 through FIG. 4. FIG. 1 is a perspective view illustrating a configuration of the energy storage apparatus 1 according to an embodiment. FIG. 1 illustrates a state in which, in the energy storage apparatus 1, a case main-body 310 is separated from a lid 320 in the metal case 300, and an energy storage device unit 30 is removed from the case main-body 310. FIG. 2 is an exploded perspective view of the energy storage device unit 30 according to an embodiment. FIG. 3 is an exploded perspective view of an energy storage device array 10 included in the energy storage device unit 30 according to an embodiment. In FIG. 3, a part of a plurality of energy storage devices 100 and a plurality of cell spacers 200 included in the energy storage device array 10 is omitted, and a first spacer group 51a disposed along the energy storage device array 10 is disassembled. FIG. 4 is a perspective view illustrating a configuration of the energy storage device 100 according to an embodiment.

The energy storage apparatus 1 is an apparatus which can be charged with electricity from outside and can discharge electricity to outside. The energy storage apparatus 1 is, for example, used for an electric energy storage purpose, a power supply purpose, and the like. The energy storage apparatus 1 is used as, for example, a battery for driving or starting an engine of a movable body such as an automobile, a motorcycle, a watercraft, a vessel, a snowmobile, an agricultural machine, a construction machine, or a railway vehicle for electric railway. As the above-mentioned automobile, an electric vehicle (EV), a hybrid electric vehicle (HEV), a plug-in hybrid electric vehicle (PHEV), and a fossil fuel (gasoline, light oil, liquefied natural gas, or the like) automobile are exemplified. As the above-mentioned railway vehicle for electric railway, a train, a monorail, a linear induction motor train, and a hybrid train provided with both a diesel engine and an electric motor are exemplified. The energy storage apparatus 1 can also be used as a stationary battery, or the like, for home or business, etc.

As illustrated in FIG. 1, the energy storage apparatus 1 includes: an energy storage device unit 30; and a metal case 300 accommodating therein the energy storage device unit 30. The energy storage apparatus 1 also includes an external terminal (positive electrode external terminal and negative electrode external terminal), or the like, for electrically coupling with an external apparatus, whose illustration and explanation are omitted. The energy storage apparatus 1 may include, aside from the above-described constituting elements, a circuit board to monitor or control a charge state, a discharge state, or the like, of the energy storage device unit 30, an electric appliance such as a relay, etc.

The energy storage device unit 30 is a battery module (assembled battery) including a plurality of energy storage devices 100. The energy storage device unit 30 has a plurality of energy storage devices 100 aligning alternately with the cell spacers 200 in the Y-axis direction, to have a substantially rectangular parallelepiped shape which is long in the Y-axis direction. The Y-axis direction is an example of a first direction. The energy storage device unit 30 also includes: a bus bar to couple the energy storage devices 100 either in series or in parallel; a bus bar frame to hold the bus bar; a bus bar to couple the energy storage devices 100 with an external terminal, or the like, whose illustration is omitted. The bus bar may couple all the energy storage devices 100 in series, may couple some of the energy storage devices 100 in parallel and then couple the energy storage devices 100 in series, or may couple all the energy storage devices 100 in parallel. Note that no rigid member, such as a member made of metal, is disposed between the energy storage device unit 30 and the metal case 300. Therefore, in the present embodiment, the energy storage device unit 30 is not constrained (pressurized) by means of any rigid member, such as a member made of metal.

More specifically, in the present embodiment, the energy storage device unit 30 includes two energy storage device arrays 10, each of which includes a plurality of energy storage devices 100 aligning in the Y-axis direction. The two energy storage device arrays 10 align in the Y-axis direction. When these two energy storage device arrays 10 are distinguished from each other, one of the two energy storage device arrays 10 is denoted as a first energy storage device array 10a, and the other is denoted as a second energy storage device array 10b, as illustrated in FIG. 2.

As illustrated in FIG. 2 and FIG. 3, the energy storage device array 10 includes a plurality of energy storage devices 100 and a plurality of cell spacers 200. In the energy storage device array 10, each cell spacer 200 is disposed between two energy storage devices 100 adjacent in the Y-axis direction. A cell spacer 200 is a member that is flat in the Y-axis direction, which is provided for electrically insulating and/or thermally insulating between the containers 110 of the two adjacent energy storage devices 100. For example, the cell spacer 200 is made of an insulating member, such as polycarbonate (PC), polypropylene (PP), polyethylene (PE), polystyrene (PS), polyphenylene sulfide resin (PPS), polyphenylene ether (PPE (including modified PPE)), polyethylene terephthalate (PET), polybutylene terephthalate (PBT), polyether ether ketone (PEEK), tetrafluoroethylene-perfluoroalkyl vinyl ether (PFA), polytetrafluoroethylene (PTFE), polyether sulfone (PES), polyamide (PA), or ABS resin, or a combination thereof; or a member having thermal insulating properties, such as mica.

In the present embodiment, the cell spacer 200 has a wall portion facing each of the energy storage devices 100 disposed on both sides of the Y-axis direction, in the Z-axis direction, the Y-axis direction, and the X-axis direction, thereby being structured to hold or support the two energy storage devices 100. For this reason, the cell spacer 200 is also referred to as “cell holder”, “holder”, or the like. The cell spacers 200 are not necessarily structured to hold or support the energy storage devices 100, and a simple plate-shaped member may be used as the cell spacer 200.

Each of the two energy storage device arrays 10 is accommodated inside the metal case 300, in a state of being surrounded by a spacer group 50, the spacer group 50 including a pair of end spacers 60 and side spacers 80 coupled to the pair of end spacers 60 (refer to FIG. 2).

In the present embodiment, a first end spacer 60a to a third end spacer 60c are disposed inside the metal case 300, as the end spacers 60 disposed at ends of the energy storage device arrays 10 in the Y-axis direction. Specifically, the first end spacer 60a is disposed at an end in the Y-axis negative direction of the two energy storage device arrays 10 aligning in the Y-axis direction, and the second end spacer 60b is disposed between the two energy storage device arrays 10. The third end spacer 60c is disposed at an end in the Y-axis positive direction of the two energy storage device arrays 10.

The first energy storage device array 10a is positioned between the first end spacer 60a and the second end spacer 60b in the Y-axis direction. The first end spacer 60a and the second end spacer 60b are coupled with each other by a pair of side spacers 80 facing in the X-axis direction. That is, the first energy storage device array 10a is surrounded by the first spacer group 51a including the first end spacer 60a, the second end spacer 60b, and the pair of side spacers 80, in the X-axis direction and the Y-axis direction (refer to FIG. 2 and FIG. 3). The X-axis direction is an example of a second direction which is orthogonal to the first direction (Y-axis direction).

The second energy storage device array 10b is positioned between the second end spacer 60b and the third end spacer 60c in the Y-axis direction. The second end spacer 60b and the third end spacer 60c are coupled with each other by a pair of side spacers 80 facing in the X-axis direction. That is, the second energy storage device array 10b is surrounded by a second spacer group 51b including the second end spacer 60b, the third end spacer 60c, and the pair of side spacers 80, in the X-axis direction and the Y-axis direction (refer to FIG. 2).

As described above, the second end spacer 60b is a spacer which is positioned between the first energy storage device array 10a and the second energy storage device array 10b, and which belongs to both of the first spacer group 51a and the second spacer group 51b. Because of being sandwiched between the first energy storage device array 10a and the second energy storage device array 10b, the second end spacer 60b can also be referred to as “intermediate spacer” or “cell spacer” from the perspective of the entire energy storage device unit 30. However, in the present embodiment, the second end spacer 60b is referred to as “end spacer 60 (second end spacer 60b)”, because of being positioned to sandwich a single energy storage device array 10 with an other end spacer 60 and being coupled with that other end spacer 60 by means of side spacers 8.

The end spacers 60 and the side spacers 80 are made of a material having insulating properties, such as PP, PE, or PE, which can be used as the material for the cell spacer 200 as described above. Therefore, the spacer group 50, constituted by the plurality of end spacers and side spacers 80, has a function to mechanically or electrically protect the two energy storage device arrays 10. That is, the spacer group 50 can protect the two energy storage device arrays 10 from shocks, or the like, and can improve insulation between the two energy storage device arrays 10 and the metal case 300.

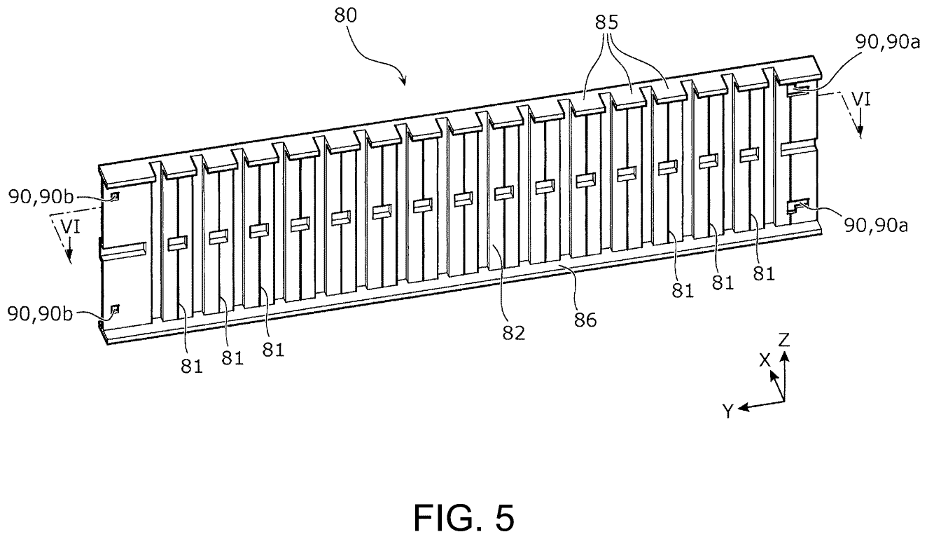

In the spacer group 50 constituted as in the above, the side spacers 80 have a characteristic configuration as can be seen in ribs, or the like, for restraining displacement of the plurality of energy storage device 100. The detailed configurations of the side spacers 80 and the end spacers 60 are described later with reference to FIG. 5 through FIG. 8C.

The energy storage element 100 is a secondary battery (a single battery) capable of charging electricity and discharging electricity, and more specifically, is a non-aqueous electrolyte secondary battery such as a lithium-ion secondary battery. The energy storage device 100 has a rectangular parallelepiped shape (square shape or square type) which is flat in the Y-axis direction. In the present embodiment, the plurality of energy storage devices 100 align in the Y-axis direction. However, the number of energy storage devices 100 provided is not particularly limited, and may be one, several tens, or even more. The size and shape of the energy storage device 100 is not particularly limited, either, and may have a long cylindrical shape, an elliptical cylindrical shape, a cylindrical shape, or a polyhedral prism shape other than a rectangular parallelepiped shape.

The energy storage device 100 is not limited to the non-aqueous electrolyte secondary battery, and may be a secondary battery other than the non-aqueous electrolyte secondary battery, or may be a capacitor. The energy storage device 100 does not have to be a secondary battery, and may be a primary battery from which electricity that is stored not by being charged by the user can be used. The energy storage device 100 may be a battery using a solid electrolyte.

As illustrated in FIG. 4, the energy storage device 100 according to the present embodiment includes: a container 110; and a pair of (positive and negative) electrode terminals 140. The container 110 accommodates inside an electrode assembly, a pair of (positive and negative) current collectors, and an electrolyte (non-aqueous electrolyte). This electrolyte may be of any type as long as it does not impair the performance of the energy storage device 100, and may be selected from various alternatives. The energy storage device 100 may include, aside from the above-described constituting elements, a spacer to be disposed on a side of the electrode assembly, an insulating film to wrap around the electrode assembly, or the like, and an insulating film (e.g. side spacers, shrink tube), or the like, to cover an outer surface of the container 110.

The container 110 is a container having a rectangular parallelepiped shape (a square shape or a box shape). The container 110 includes: a container main-body 120 provided with an opening; and a container lid portion 130 to close the opening of the container main-body 120. The container main-body 120 is a member in a rectangular cylindrical shape having a bottom, making up a main-body portion of the container 110. The container main-body 120 has an opening at an end in a Z-axis positive direction. The container lid portion 130 is a plate-shaped member in a rectangular shape, which is long in the X-axis direction, making up a lid portion of the container 110. The container lid portion 130 is disposed in the Z-axis positive direction of the container main-body 120. The container lid portion 130 is provided with: a gas exhaust valve 131 to release pressure inside the container 110 in case the pressure is raised excessively; a liquid wetted portion (not illustrated) inside the container 110 for liquid injection, and the like. The material of the container 110 (the container main-body 120 and the container lid portion 130) is not particularly limited. For example, while a weldable (joinable) metal such as stainless steel, aluminum, an aluminum alloy, iron, or a plated steel plate can be employed, a resin can also be used.

The container 110 is sealed and is airtight as a result of joining the main-body 120 and the container lid portion 130 by welding or the like, after an electrode assembly, or the like, is accommodated inside the container main-body 120. The container 110 includes: a pair of long side surfaces 111 on both sides of the Y-axis direction; a pair of short side surfaces 112 on both sides of the X-axis direction; and a bottom surface 113 in a position facing the container lid portion 130 in the Z-axis direction. The Z-axis direction is an example of a third direction which is orthogonal to the first direction and the second direction. The long side surfaces 111 are adjacent to the short side surfaces 112 and the bottom surface 113, and are larger in area than the short side surfaces 112. The short side surfaces 112 are adjacent to the long side surfaces 111 and the bottom surface 113, and are smaller in area than the long side surfaces 111. The bottom surface 113 is a planar portion in a rectangular shape, making up a bottom surface of the container 110. The bottom surface 113 is disposed adjacent to the long side surfaces 111 and the short side surfaces 112.

The electrode terminals 140 are terminal members (positive electrode terminal and negative electrode terminal) of the energy storage device 100, and are disposed on the container lid portion 130. Specifically, the electrode terminals 140 are disposed in a state protruding from an upper surface (terminal-disposing surface) of the container lid portion 130 towards the Z-axis positive direction. The electrode terminals 140 are electrically coupled to a positive electrode plate and a negative electrode plate of the electrode assembly via the current collector. The electrode terminals 140 is made of aluminum, an aluminum alloy, copper, a copper alloy, or the like.

The electrode assembly is an energy storage element (power generating element) formed by stacking a positive electrode plate, a negative electrode plate, and a separator. The positive electrode plate is made by forming a positive electrode active material layer on a positive electrode base material layer being current collector foil made of metal such as aluminum or an aluminum alloy. The negative electrode plate is made by forming a negative electrode active material layer on a negative electrode base material layer being current collector foil made of metal such as copper or a copper alloy. The active material used for the positive electrode active material layer and the negative electrode active material layer may be any known material as long as it can store and discharge lithium ions. As the separator, a microporous sheet, non-woven fabric, or the like, made of resin may be used. In the present embodiment, the electrode assembly is a winding electrode assembly formed by winding an electrode plate (the positive electrode plate and the negative electrode plate). The electrode assembly included in the energy storage device 100 may be any type of electrode assembly such as a stacked-layer type (stack type) electrode assembly formed by stacking a plurality of plate-shaped electrode plates and a bellows-type electrode assembly formed by folding an electrode plate in a bellows style.

The current collector is a conductive current collector member (positive electrode current collector and negative electrode current collector), which is either electrically or mechanically coupled to the electrode terminal 140 and the electrode assembly. The positive electrode current collector is made of aluminum or an aluminum alloy, etc. just as the positive electrode base material layer of the positive electrode plate of the electrode assembly. The negative electrode current collector is made of copper or a copper alloy, etc. just as the negative electrode base material layer of the negative electrode plate of the electrode assembly.

The metal case 300 is a container in a substantially rectangular parallelepiped shape (box shape), making up an outer body (outer shell) of the energy storage apparatus 1. The metal case 300 is disposed outside the energy storage device unit 30, fixes the energy storage device unit 30 in a predetermined position, and protects the energy storage device unit 30 from shocks, etc. The metal case 300 is a metal case made of a member made of metal, such as aluminum, an aluminum alloy, stainless steel, iron, and a plated steel plate. In the present embodiment, the metal case 300 is formed by die casting aluminum (aluminum die casting).

As illustrated in FIG. 1, the metal case 300 includes: a case main-body 310 making up a main body of the metal case 300; and a lid 320 to close the opening portion 310a of the case main-body 310. The case main-body 310 is a housing (case) provided with an opening portion 310a opening in the Z-axis positive direction (one side of the third direction which is orthogonal to the first direction and the second direction). The case main-body 310 accommodates therein the energy storage device unit 30 (the two energy storage device arrays 10 and the spacer group 50). Specifically, the case main-body 310 includes: a pair of side wall portions 312 disposed at both ends in the X-axis direction; a first end wall portion 313 disposed at an end in the Y-axis negative direction; a second end wall portion 314 disposed at an end in the Y-axis positive direction; and a bottom wall portion 315 disposed at a position facing the opening portion 310a. Note that the metal case main-body 310 is a housing (case) of one piece in which the first end wall portion 313, the second end wall portion 314, and the bottom wall portion 315 are continuously formed.

The lid 320 is a member in a flat rectangular shape which closes the opening portion 310a of the case main-body 310. After the energy storage device unit 30 is inserted from the opening portion 310a of the case main-body 310, the case main-body 310 and the lid 320 are joined together by fastening using bolts or the like, welding, adhesive bonding, or the like. Accordingly, the metal case 300 has a sealed (airtight) structure. To the case main-body 310 or the lid 320, a terminal board for the external terminal (the positive electrode external terminal and the negative electrode external terminal) may be mounted, and the external terminal may be disposed on the terminal board.

In the energy storage apparatus 1 structured in the above manner, a plurality of energy storage devices 100 included in a single energy storage device array 10 is surrounded by a pair of end spacers 60 and side spacers 80 respectively coupled with the pair of end spacers 60. In the present embodiment, these end spacers 60 and the side spacers 80 help obtain an effect of restraining displacement of the plurality of energy storage devices 100 included in the energy storage device array 10, improving shock resistance or vibration resistance, or the like. Hereinafter, a configuration of the side spacers 80 and the end spacers 60 is described with reference to FIG. 5 through FIG. 8C, in addition to FIG. 1 through FIG. 4.

### [2. Configuration of Side Spacers and End Spacers]

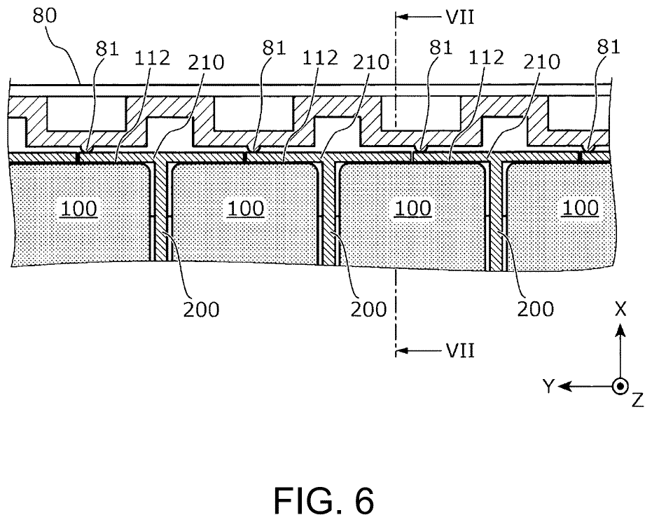

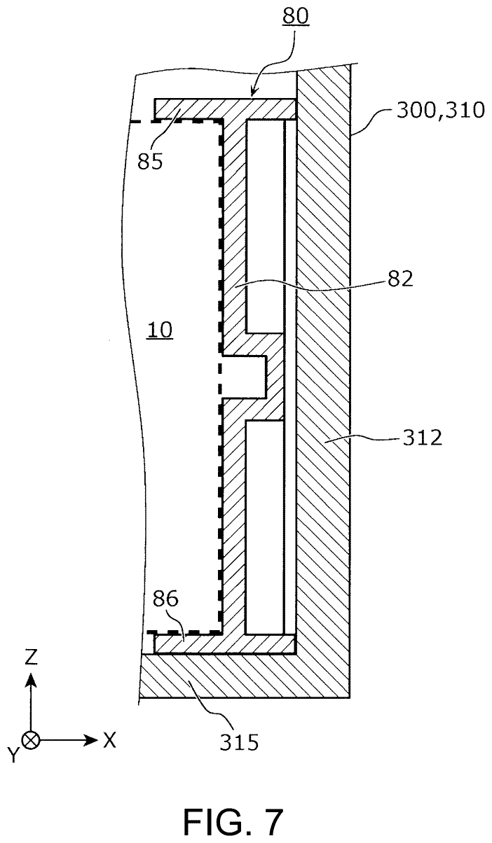

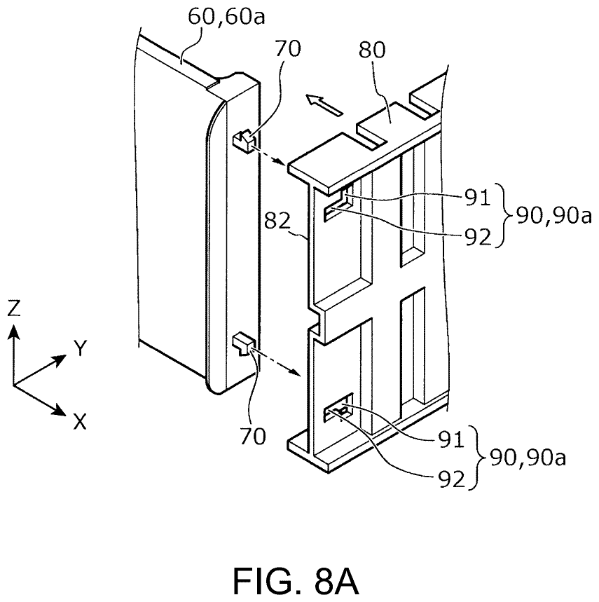

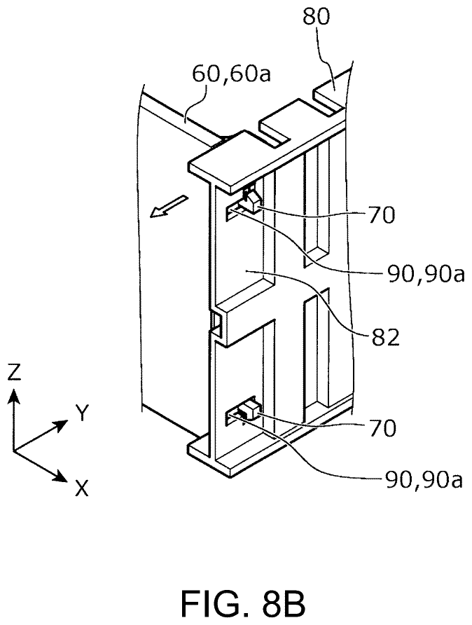

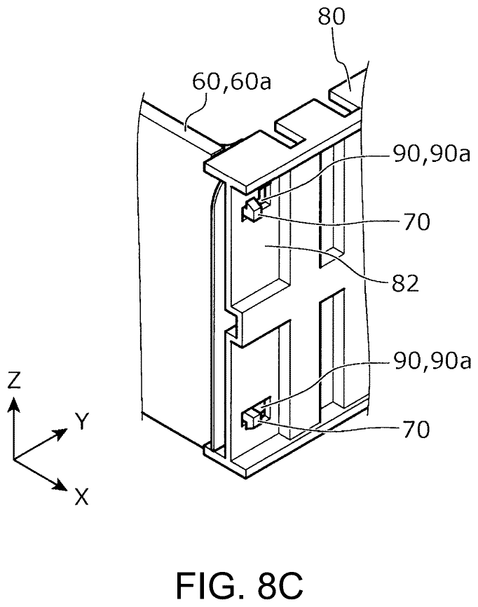

FIG. 5 is a perspective view illustrating a configuration of a side spacer 80 according to an embodiment. In FIG. 5, a side spacer 80 to be disposed on a side of the first energy storage device array 10a in the X-axis positive direction (refer to FIG. 2) is illustrated in a posture in which a side surface to face the first energy storage device array 10a is visible. FIG. 6 is a sectional view illustrating a structural relationship between energy storage devices 100 and ribs 81 included in the side spacer 80. In FIG. 6, a part of a sectional view of the side spacer 80 and the cell spacer 200 in an X-Y plane passing through a line VI-VI in FIG. 5 is illustrated as a simplified view, whereas an approximate range in which the energy storage devices 100 are disposed is represented by dotted areas. FIG. 7 is a sectional view illustrating a structural relationship between the side spacer 80 and the energy storage device array 10, according to an embodiment. In FIG. 7, the side spacer 80 on a VII-VII section in FIG. 6 is illustrated as a simplified view, whereas an approximate range in which the energy storage device unit 30 is disposed is represented as an area surrounded by a dotted line. FIG. 8A through FIG. 8C are first to third perspective views each illustrating a coupling structure between a side spacer 80 and an end spacer 60, according to an embodiment. In FIG. 8A through FIG. 8C, illustration of the energy storage device array 10 surrounded by the side spacer 80 and the end spacer 60 is omitted.

As illustrated in FIG. 5 and FIG. 6, the side spacer 80 includes ribs 81 disposed at positions to face the plurality of energy storage devices 100, respectively. More specifically, the side spacer 80 includes: a side spacer main-body portion 82; a first flange portion 86 disposed at an end in the Z-axis negative direction of the side spacer main-body portion 82; and second flange portions 85 disposed at an end in the Z-axis positive direction of the side spacer main-body portion 82.

As illustrated in FIG. 2, FIG. 3, FIG. 5, and FIG. 6, the side spacer main-body portion 82 is a portion elongated in the Y-axis direction, making up a main body of the side spacer 80, and has improved rigidity by having a plurality of convex and concave shapes. Ribs 81, which are elongated in the Z-axis direction, are provided for the side spacer main-body portion 82 in positions facing the plurality of energy storage devices 100, respectively. The ribs 81 are portions integrally formed with the side spacer main-body portion 82, and are formed at predetermined positions by a mold to shape the side spacer 80 made of resin.

As illustrated in FIG. 6, when in a state of being accommodated in the metal case 300 while the side spacer 80 and the end spacer 60 are disposed with respect to the energy storage device array 10, this rib 81 can push the energy storage device 100 that is in a position to face the rib 81, in a protruding direction of the rib 81. In the present embodiment, since a concave portion is formed on an inner surface of the side spacer main-body portion 82 (i.e., surface facing the energy storage device array 10), the rib 81, which is elongated in the Z-axis direction, is divided by the concave portion in the middle in the Z-axis direction. However, this structure is not always necessary. The rib 81 may be disposed in any position in the Z-axis direction of the side spacer main-body portion 82, as long as it is in a position capable of pushing, directly or indirectly, the energy storage device 100 that is in a position facing that rib 81 in the X-axis direction.

In FIG. 6, so as to clearly illustrate the ribs 81, the ribs 81 before being compressed are illustrated. However, in reality, the ribs 81 can be compressed (crushed) in response to a reaction force from the energy storage devices 100. Therefore, even in a case where the sizes of the plurality of energy storage devices 100 in the X-axis direction differ due to the tolerance, each of the plurality of ribs 81 can absorb the tolerance and can push, in the X-axis direction, the energy storage device 100 facing that rib 81.

In the present embodiment, each of the plurality of ribs 81 is configured to push the energy storage device 100 via the cell spacer 200. Specifically, the cell spacer 200 includes a side-surface cover portion 210 (refer to FIG. 3 and FIG. 6) in a position facing the short side surface 112 (refer to FIG. 4) of the energy storage device 100. As illustrated in FIG. 6, the ribs 81 included in the side spacer 80 push the energy storage devices 100 via the side-surface cover portions 210. More specifically, as illustrated in FIG. 6, the side-surface cover portions 210 of the cell spacers 200 are easily warped towards the energy storage devices 100, because their ends in the Y-axis direction, being free ends, are pushed in the X-axis negative direction by the ribs 81. Therefore, even in a case where the pressure force by the rib 81 is comparably small, the pressure force can be efficiently conveyed to the energy storage device 100 via the side-surface cover portions 210.

The ribs 81 do not necessarily push the energy storage devices 100 via the cell spacers 200. If the energy storage device array 10 does not include any cell spacer 200, or if the cell spacers 200 are simple plate-shaped members which do not have any structure to hold or support the energy storage devices 100, or in other cases, the ribs 81 may directly push the short side surfaces 112 of the energy storage devices 100. In the present embodiment, the ribs 81 are integrally formed with the side spacer 80, and the side spacer 80 is made of an insulating material such as resin. Therefore, even in a case where the ribs 81 directly contact the container 110 for the energy storage devices 100, a problem of degradation of insulating properties between the energy storage devices 100 and the metal case 300 hardly occurs.

The first flange portion 86 is a portion that is disposed at an end in the Z-axis negative direction of the side spacer main-body portion 82, and that protrudes along the X-axis direction. As illustrated in FIG. 7, the first flange portion 86 contacts an end in the Z-axis negative direction of the energy storage device array 10, and supports the energy storage device array 10. Specifically, each of the plurality of cell spacers 200 included in the energy storage device array 10 includes a bottom-surface cover portion 220 (refer to FIG. 3) which faces the bottom surface 113 (refer to FIG. 4) of the energy storage device 100. The first flange portion 86 contacts the bottom-surface cover portions 220 of the plurality of cell spacers 200, thereby supporting the energy storage device array 10 from below (Z-axis negative direction).

The second flange portions 85 are portions that are disposed at an end in the Z-axis positive direction of the side spacer main-body portion 82, and that protrude along the X-axis direction. As illustrated in FIG. 7, the second flange portions 85 press the end in the Z-axis positive direction of the energy storage device array 10 towards the Z-axis negative direction. Specifically, each of the plurality of cell spacers 200 included in the energy storage device array 10 includes an upper-surface cover portion 230 (refer to FIG. 3) which faces the container lid portion 130 (refer to FIG. 4) of the energy storage device 100. The second flange portions 85 contact the upper-surface cover portions 230 of the plurality of cell spacers 200, thereby pressing the end in the Z-axis positive direction of the energy storage device array 10 towards Z-axis negative direction.

The side spacer 80 configured in the above manner is coupled to each of the pair of end spacers 60. That is, the end spacers 60 are coupled to both ends of the side spacer 80 in the Y-axis direction. In the present embodiment, protrusions 70 included in the end spacer 60 are inserted in insertion portions 90 of the side spacers 80, thereby coupling the side spacer 80 to the end spacers 60. More specifically, in the present embodiment, in one of both ends in the Y-axis direction of the side spacer 80, the end spacer 60 is coupled to the side spacer 80 in a freely movable state in the Y-axis direction with respect to the side spacer 80, as illustrated in FIG. 8A through FIG. 8C. FIG. 8A through FIG. 8C illustrate a coupling structure between the side spacer 80 disposed in the X-axis positive side of the first energy storage device array 10a (refer to FIG. 2 and FIG. 3) and the end spacer 60 (first end spacer 60a). As illustrated in FIG. 8A, the protrusions 70 included in the end spacer 60 each include a hook portion at a tip end of the protruding direction. The insertion portions 90 provided in an end in the Y-axis negative direction of the side spacer 80 are each provided with a long hole which is elongated in the Y-axis direction, so as to allow movement of the protrusion 70 in the Y-axis direction. This insertion portion 90 is denoted as an insertion portion 90a to distinguish it from the other insertion portion(s) 90. Specifically, the insertion portion 90a includes: a large hole portion 91 having a size through which the hook portion of the protrusion 70 can penetrate; and a small hole portion 92 having a size through which the inserted hook portion cannot remove. The small hole portion 92 provided to continue to the large hole portion 91 and to elongate in the Y-axis negative direction from the large hole portion 91. When coupling the side spacer 80 to the end spacer 60, as illustrated in FIG. 8A and FIG. 8B, the protrusion 70 of the end spacer 60 is inserted in the large hole portion 91 of the insertion portion 90a of the side spacer 80. In the state in which the protrusion 70 is inserted in the large hole portion 91, the end spacer 60 or the side spacer 80 is moved in the Y-axis direction so as to move the end spacer 60 in the Y-axis negative direction with respect to the side spacer 80. As a result, as illustrated in FIG. 8C, the protrusion 70 of the end spacer 60 is slid to the position of the small hole portion 92 of the insertion portion 90a, thereby making the protrusion 70 unable to be removed from the insertion portion 90a and making the protrusion 70 movable in the Y-axis direction. In the present embodiment, two sets of such protrusion 70 and insertion portion 90a are provided in the Z-axis direction. In also the end in the X-axis negative direction of the end spacer 60, two sets of such protrusion 70 and insertion portion 90a are provided in the Z-axis direction. Accordingly, the end spacer 60 can stably move in the Y-axis direction within a predetermined range with respect to the pair of side spacers 80 to be coupled to both ends in the X-axis direction of the end spacer 60.

In this way, the end spacer 60 coupled to the side spacer 80 by mechanical engagement between the protrusions 70 and the insertion portions 90 is in a freely movable state in the Y-axis direction with respect to the side spacer 80. That is, a relative position of the end spacer 60 with respect to the side spacer 80 in the Y-axis direction has a degree of freedom within a predetermined range. Therefore, after the first spacer group 51a is disposed in the first energy storage device array 10a as illustrated in FIG. 2 and FIG. 3, the first end spacer 60a can be pressurized in a direction to compress the first energy storage device array 10a (Y-axis positive direction). Accordingly, a length of the first energy storage device array 10a in the Y-axis direction can be made shorter than that before being pressurized, and the first energy storage device array 10a can be accommodated in the case main-body 310 of the metal case 300 in this state.

More specifically, in the present embodiment, also in a second spacer group 51b surrounding the second energy storage device array 10b as illustrated in FIG. 2, the third end spacer 60c positioned at an end in the Y-axis positive direction is coupled to be freely movable in the Y-axis direction with respect to the side spacer 80. Therefore, from the perspective of the entire energy storage device unit 30, by pushing each of the first end spacer 60a and the third end spacer 60c to approach each other, a length of the energy storage device unit 30 in the Y-axis direction can be made smaller than that before being pressurized. If the energy storage device unit 30 is accommodated in the case main-body 310 of the metal case 300 in this state and then the pressure is released, the entire length of the energy storage device unit 30 in the Y-axis direction is elongated so as to return to the state before pressurization. Accordingly, the end surface (end spacer end surface 61; refer to FIG. 3) of the first end spacer 60a in the Y-axis negative direction can be brought in contact with an inner surface of the first end wall portion 313 (refer to FIG. 1) of the metal case 300. Likewise, also in the third end spacer 60c, the end surface in the Y-axis positive direction can be brought in contact with an inner surface of the second end wall portion 314 (refer to FIG. 1) of the metal case 300. As a result, the energy storage device unit 30 which includes the two energy storage device arrays 10 is brought in a state constrained in the Y-axis direction by the metal case 300.

As stated so far, the energy storage apparatus 1 according to the present embodiment includes: the energy storage device array 10 which includes the plurality of energy storage devices 100 stacked in the Y-axis direction; the pair of end spacers 60; the side spacers 80; and the metal case 300. The pair of end spacers 60 are disposed in positions to sandwich the energy storage device array 10 in the Y-axis direction. The side spacers 80 are disposed on sides of the energy storage device array 10 in the X-axis direction which is orthogonal to the Y-axis direction, and are coupled to the pair of end spacers 60, respectively. The metal case 300 accommodates therein the energy storage device array 10, the pair of end spacers 60, and the side spacers 80. The side spacer 80 includes a plurality of ribs 81 protruding towards the energy storage device array 10. The plurality of ribs 81 are integrally formed with the side spacer 80, and each of the ribs 81 pushes one of the plurality of energy storage devices 100, which is positioned to face that rib 81, towards the protruding direction of that rib 81.

According to this configuration, movement of the energy storage device array 10 within the metal case 300 can be restricted by means of the end spacers 60 positioned on both sides of the Y-axis direction and the side spacers 80 coupling the pair of end spacers 60. More specifically, the side spacer 80 includes the plurality of ribs 81 which are respectively in contact with the plurality of energy storage devices 100 included in the energy storage device array 10. For this reason, it is possible to accommodate the tolerance in size of the plurality of energy storage devices 100, and to align the position of the plurality of energy storage devices 100 in the X-axis direction at the same time. That is, the plurality of energy storage devices 100 can be aligned with accuracy, and displacement of the plurality of energy storage devices 100 attributed to vibration, shock, etc. is restrained. Since the plurality of ribs 81 are integrally formed with the side spacer 80, no separate member to push the plurality of energy storage devices 100 is necessary. No new structure to be pushed by the ribs 81 is necessary for the energy storage device array 10 which includes the plurality of energy storage devices 100. In this manner, the energy storage device 100 according to the present aspect is an energy storage apparatus having a simple configuration with improved reliability.

In the present embodiment, a plurality of ribs 81 are provided for each of the pair of side spacers 80 (refer to FIG. 3) which face each other in the X-axis direction. Therefore, each of the plurality of energy storage devices 100 is pushed from both sides of X-axis direction. As a result, each of the plurality of energy storage devices 100 receives forces from the pair of side spacers 80 so that the center thereof in the X-axis direction approaches an intermediate position between the pair of side spacers 80 in the X-axis direction. Accordingly, the position in the X-axis direction of the plurality of energy storage devices 100 aligning in the Y-axis direction is easily aligned, and displacement of the plurality of energy storage devices 100 in the X-axis direction is restrained. It is not necessary that both of the pair of side spacers 80 have ribs 81. Only the side spacer 80 in the X-axis negative direction may include a plurality of ribs 81. In this case, the positions of the plurality of energy storage devices 100 in the X-axis direction can be aligned, using an inner surface of the side spacer 80 in the X-axis positive direction as a reference.

In the present embodiment, as illustrated in FIG. 8A through FIG. 8C, one of a pair of end spacers 60 is coupled to the side spacer 80 in a freely movable state in the Y-axis direction with respect to the side spacer 80.

According to this configuration, the freely movable end spacer 60 is pressurized in the Y-axis direction, thereby allowing the energy storage device array 10 to be accommodated in the metal case 300 by pressurizing the energy storage device array 10 in the Y-axis direction. By releasing the pressure to the energy storage device array 10, the energy storage device array 10 can push back the freely movable end spacer 60, thereby bringing the energy storage device array 10 into a state constrained in the Y-axis direction by the metal case 300. Accordingly, the position of the energy storage device array 10 in the metal case 300 is stabilized. As a result, the energy storage device array 10 has improved vibration resistance or shock resistance.

More specifically, in the present embodiment, in the energy storage device unit 30 which includes the two energy storage arrays 10 aligning in the Y-axis direction as stated above, the end spacers 60 (the first end spacer 60a and the third end spacer 60c) in both ends of the Y-axis direction can move freely in the Y-axis direction. Therefore, the energy storage device unit 30 can be accommodated in the metal case 300 while compressing the entire energy storage device unit 30 in the Y-axis direction. As a result, the energy storage device unit 30 can be brought into a state constrained in the Y-axis direction by the metal case 300. Accordingly, the position of the energy storage device unit 30 in the metal case 300 is stabilized. As a result, the energy storage device unit 30 has improved vibration resistance or shock resistance.

In the present embodiment, the following configuration is adopted as a configuration to couple the end spacer 60 in a freely movable state in the Y-axis direction with respect to the side spacers 80. That is, either one end spacer 60 of the pair of end spacers 60 or the side spacers 80 has protrusions 70 protruding in the X-axis direction. The other of the one end spacer 60 and the side spacers 80 has insertion portions 90a (refer to FIG. 8A), into which the protrusions 70 are inserted. The insertion portions 90a are shaped to enable movement of the protrusions 70 towards the Y-axis direction. By insertion of the protrusions 70 into the insertion portions 90a, either the one end spacer 60 or the side spacers 80 is coupled to the other in a freely movable state in the Y-axis direction. In the present embodiment, the protrusions 70 are provided for the end spacer 60, and the insertion portions 90a are provided for the side spacers 80.

According to this configuration, a mechanically engaged state of the end spacer 60 and the side spacers 80 is maintained by a simple configuration of the protrusion(s) 70 and the insertion portion(s) 90a, and a degree of freedom in position of the end spacer 60 with respect to the side spacers 80 in the Y-axis direction is maintained at the same time.

It is not necessary to provide the end spacer 60 with protrusions 70 and provide the side spacer 80 with insertion portions 90a. It is possible to provide the side spacer 80 with protrusions 70, and provide the end spacer 60 with insertion portions 90a.

In the present embodiment, the side spacers 80 are made of resin. Therefore, the side spacers 80 also function as an insulating member to electrically insulate the energy storage device array 10 from the wall portions (the side wall portions 312) of the metal case 300. The side spacers 80 are members to couple the pair of end spacers 60. Meanwhile, constraint of the energy storage device array 10 in the Y-axis direction can be performed by the metal case 300, as described above. Therefore, a problem regarding strength of the side spacers 80 due to the side spacers 80 being made of resin hardly occur.

According to the present embodiment, as illustrated in FIG. 1, the metal case 300 includes an opening portion 310a which opens towards one side of the Z-axis direction (i.e., Z-axis positive direction) orthogonal to the Y-axis direction and the X-axis direction. The opening portion 310a can accommodate therein the energy storage device array 10. The side spacers 80 each have a first flange portion 86 which is in contact with an end of the energy storage device array 10 on the other side of the Z-axis direction (i.e., Z-axis negative direction), so as to support the energy storage device array 10.

According to this configuration, the energy storage device array 10 which includes the plurality of energy storage devices 100, in the state before being accommodated in the metal case 300, can be supported from below by the first flange portion 86. Therefore, stability of the energy storage device array 10 improves during an operation to place the energy storage device array 10 into the metal case 300 while pressurizing the energy storage device array 10 in the Y-axis direction. Accordingly, the energy storage device array 10 can be accommodated in the metal case 300 with accuracy. This contributes to improvement in reliability of the energy storage apparatus 1. In the present embodiment, the first flange portion 86 can collectively support the two energy storage device arrays 10 aligning in the Y-axis direction in energy storage device unit 30. Therefore, the energy storage device unit 30 can be accommodated in the metal case 300 with accuracy.

According to the present embodiment, as illustrated in FIG. 1, the metal case 300 includes an opening portion 310a which opens towards one side of the Z-axis direction (i.e., Z-axis positive direction) orthogonal to the Y-axis direction and the X-axis direction. The opening portion 310a can accommodate therein the energy storage device array 10. The side spacers 80 each have second flange portions 85 which press the end of the energy storage device array 10 on one side of the Z-axis direction (i.e., Z-axis positive direction) towards the other side in the Z-axis direction (i.e., Z-axis negative direction). In other words, the side spacer 80 has second flange portions 85 in contact with the end on one side of the third direction of the energy storage device array 10.

According to this configuration, upper ends of the plurality of energy storage devices 100 are pressed by the second flange portions 85. Accordingly, upward movement of the plurality of energy storage devices 100 is restricted. Accordingly, joining accuracy between the bus bar (not illustrated) and the electrode terminal 140 during manufacture of the energy storage apparatus improves. Vibration resistance or shock resistance during usage improves. In the present embodiment, the second flange portions 85 can press down the plurality of energy storage devices 100, respectively, which are included in the two energy storage device arrays 10 included in the energy storage device unit 30, via the cell spacers 200. Therefore, improvement in joining accuracy between the bus bar and the electrode terminal 140 and further improvement in vibration resistance or shock resistance during usage, etc. can be attempted in each of the plurality of energy storage devices 100 included in the energy storage device unit 30.

### [3. Modifications]

So far, an energy storage apparatus 1 according to an embodiment of the present invention has been described. However, the present invention is not limited to the above-described embodiment. The embodiment disclosed herein is illustrative in all aspects, and the scope of the present invention includes all modifications within the meaning and scope of equivalence with the scope of claims.

The energy storage device array 10 does not have to include a cell spacer 200. In a case where an insulating member, such as a film made of resin, is attached to a container 110 of each of the plurality of energy storage devices 100 included in the energy storage device array 10, it is not necessary to dispose a cell spacer 200 between each two adjacent energy storage devices 100.

A shape and size of the side spacer 800 illustrated in FIG. 3, FIG. 5, etc. is illustrative. The shape and size of the side spacer 80 may be determined as necessary, depending on the size or shape, etc. of the energy storage device 100 included in the energy storage device array 10. At least one of the first flange portion 86 and the second flange portions 85 may be omitted in the side spacer 80.

The configuration to couple the end spacer 60 in a freely movable state in the Y-axis direction with respect to the side spacer 80 is not necessarily realized by the long holes (the insertion portions 90a) and the protrusions 70 as illustrated in FIG. 8A through FIG. 8C. The end spacer 60 and the side spacer 80 may be coupled by a resilient member, such as a spring or rubber, to enable the end spacer 60 coupled to the side spacer 80 to be freely movable in the Y-axis direction with respect to the side spacer 80. The insertion portion 90a does not have to penetrate the side spacer 80 in the X-axis direction. The insertion portion 90a may be a groove (groove not penetrating in the X-axis direction) elongating in the Y-axis direction, provided on an inner surface facing the energy storage device array 10 of the side spacer 80.

In the above-described embodiment, the insertion portion 90 (refer to FIG. 5) provided on an end in the Y-axis positive direction of the side spacer 80 included in the first spacer group 51a is a hole (the insertion portion 90b) formed in a shape not substantially allowing movement of the protrusion 70 in the Y-axis direction, unlike the insertion portion 90a. However, that side spacer 80 may include, at the end in the Y-axis positive direction, an insertion portion 90a in a shape allowing movement of the protrusion 70 in the Y-axis direction, instead of the insertion portion 90b. That is, sets of the protrusion 70 and the insertion portion 90a to couple the side spacer 80 and the end spacer 60 in a state allowing the mutual movement in the Y-axis direction may be disposed at both ends in the Y-axis direction of the side spacer 80, respectively. The number of sets of the protrusion 70 and the insertion portion 90a disposed at one end in the Y-axis direction of the side spacer 80 does not have to be two, and may be one, or may be three or more.

The energy storage device unit 30 does not have to include the second end spacer 60b. That is, the entirety of the plurality of energy storage devices 100 included in the energy storage device unit 30 may be sandwiched between the pair of end spacers 60 (the first end spacer 60a and the third end spacer 60c) in the Y-axis direction. In this case, side spacers 80 having a size and shape to be able to couple the first end spacer 60a and the third end spacer 60c may be used. That is, the number of the energy storage device arrays 10 to be included in the energy storage device unit 30 may be one or more. The number of energy storage devices 100 to be included in the energy storage device array 10 may also be one or more.

There is no particular limitation on the number of energy storage device units 30 (energy storage device arrays 10) to be accommodated in the metal case 300. The metal case 300 may be formed in a size and shape to be able to accommodate the plurality of energy storage device units 30 aligning in the X-axis direction or the Y-axis direction.

In the above-described embodiment, the side spacer 80 includes a plurality of ribs 81. However, the number of ribs 81 to be included in the side spacer 80 may be one.

Forms constructed by arbitrarily combining constituting elements included in the above-described embodiment and the modification examples thereof are also included in the scope of the present invention.

### INDUSTRIAL APPLICABILITY

The present invention can be applied to an energy storage apparatus, etc., provided with an energy storage device such as a lithium-ion secondary battery.

### DESCRIPTION OF REFERENCE NUMERALS

1 Energy storage apparatus
10 Energy storage device array
10a First energy storage device array
10b Second energy storage device array
60 End spacer
60a First end spacer
60b Second end spacer
60c Third end spacer
70 Protrusion
80 Side spacer
81 Rib
85 Second flange portion
86 First flange portion
90, 90a Insertion portion
91 Large hole portion
92 Small hole portion
100 Energy storage device
300 Metal case

1. An energy storage apparatus comprising:
an energy storage device array which includes a plurality of energy storage devices stacked in a first direction;
a pair of end spacers disposed in positions to sandwich the energy storage device array in the first direction;
a side spacer disposed on a side of the energy storage device array, in a second direction orthogonal to the first direction, the side spacer being coupled to each of the pair of end spacers; and
a metal case to accommodate the energy storage device array, the pair of end spacers, and the side spacer, wherein
the side spacer includes a rib protruding towards the energy storage device array, and
the rib is provided integrally with the side spacer, and is in contact with an energy storage device, among the plurality of energy storage devices, which is in a position facing the rib.

2. The energy storage apparatus according to claim 1, wherein
one end spacer, of the pair of end spacers, is coupled to the side spacer in a freely movable state in the first direction with respect to the side spacer.

3. The energy storage apparatus according to claim 2, wherein
one of the one end spacer and the side spacer includes a protrusion protruding towards the second direction, and
an other of the one end spacer and the side spacer includes an insertion portion into which the protrusion is inserted, the insertion portion being shaped to enable movement of the protrusion towards the first direction, and
by insertion of the protrusion into the insertion portion, the one of the one end spacer and the side spacer is coupled to the other of the one end spacer and the side spacer in a freely movable state in the first direction.

4. The energy storage apparatus according to claim 1, wherein
the side spacer is made of resin.

5. The energy storage apparatus according to claim 1, wherein
the metal case includes an opening portion which opens towards one side of a third direction orthogonal to the first direction and the second direction, the opening portion being capable of accommodating the energy storage device array, and
the side spacer includes a first flange portion which is in contact with an end of the energy storage device array on an other side of the third direction.

6. The energy storage apparatus according to claim 1, wherein
the metal case includes an opening portion which opens towards one side of a third direction orthogonal to the first direction and the second direction, the opening portion being capable of accommodating the energy storage device array, and
the side spacer includes second flange portion which is in contact with an end of the energy storage device array on the one side of the third direction.
